(19) United States
(12) Patent Application Publication
(10) Pub. No.: US 2025/0208274 A1
(43) Pub. Date: Jun. 26, 2025

(54) SENSOR UNIT FOR ASCERTAINING AN ORIENTATION OF THE SENSOR UNIT

(71) Applicant: Robert Bosch GmbH, Stuttgart (DE)

(72) Inventor: Stefano De Blasi, Reutlingen (DE)

(21) Appl. No.: 18/981,763

(22) Filed: Dec. 16, 2024

(30) Foreign Application Priority Data
Dec. 22, 2023 (DE) 10 2023 213 264.8

(51) Int. Cl. G01S 7/52; G01S 15/931

(52) U.S. Cl. CPC G01S 7/52004; G01S 15/931; G01S 2015/938

(57) ABSTRACT

A sensor unit configured to ascertain an orientation of the sensor unit. The sensor unit includes: a printed circuit board unit, at least two sensor elements. The at least two sensor elements are arranged on the printed circuit board unit. The at least two sensor elements are configured to transmit and/or receive at least a first ultrasonic wave. The sensor unit is configured to ascertain the orientation of the sensor unit in relation to a reference of a vehicle by adjusting the first transmitted ultrasonic wave using the at least two sensor elements.

### CROSS REFERENCE

The present application claims the benefit under 35 U.S.C. § 119 of German Patent Application No. DE 10 2023 213 264.8 filed on Dec. 22, 2023, which is expressly incorporated herein by reference in its entirety.

### FIELD

The present invention relates to a sensor unit for ascertaining an orientation of the sensor unit and to a vehicle.

### BACKGROUND INFORMATION

At present, there are a variety of different solutions for ascertaining alignments of ultrasonic range sensors. As the number of ultrasonic sensors in the automotive sector increases and the quality requirements rise, the need for innovative and robust ultrasonic measurement systems continues to grow.

Continuous weight reduction in the vehicle sector to reduce consumption, along with increasing competition, creates cost pressure, thus driving higher demand for more cost-effective and efficient components for vehicles.

### SUMMARY

The sensor unit according to the present invention for ascertaining an orientation of the sensor unit may have the advantage over conventional sensor units that, by ascertaining the orientation of the sensor unit in relation to a reference of the vehicle, a correct installation and positioning of the individual ultrasonic sensor unit as well as its positioning in the ultrasonic sensor system can be checked. Another advantage is that, by referencing multiple ultrasonic sensor units in relation to one another, statistical models can be used to be able to check the correct installation of the sensor unit.

According to an example embodiment of the present invention, this is achieved in that the sensor unit for ascertaining an orientation of the sensor unit includes a printed circuit board unit as well as at least two sensor elements. The at least two sensor elements are arranged on the printed circuit board unit, wherein the at least two sensor elements are configured to transmit and/or receive at least a first ultrasonic wave, wherein the sensor unit is configured to ascertain the orientation of the sensor unit in relation to a reference of a vehicle by adjusting the first transmitted ultrasonic wave by means of the at least two sensor elements.

In other words, by using the beamsteering capability of a MEMS ultrasonic sensor array in a defined measurement process, the wave front can be directed at defined angular adjustments to the ground so that the reflected wave can be received at the same ultrasonic array in order to be able to ascertain the orientation of the vehicle. For example, the sensor unit may be a MEMS-based ultrasonic sensor. Preferably, the sensor unit may comprise a plurality of sensor elements, which, for example, form an ultrasonic array with an orientation of 2×2 sensor elements. Further preferably, a plurality of printed circuit board units, each comprising a plurality of sensor elements, may also be provided on a vehicle. The reference of the vehicle may in particular be a coordinate system or the like, for example in accordance with DIN 70000. It can thus be ascertained whether or not the sensor unit in the vehicle has been installed in the intended orientation or positioning in the vehicle. Further preferably, deformations of the bumper in which the sensor unit may be installed may also be ascertained after an accident or technically incorrect installation since the orientation of the sensor unit deviates from the predetermined orientation. Preferably, the orientation of the sensor units in relation to a predetermined orientation may in particular be ascertained and, if it deviates by a predetermined value, a signal is output by the sensor unit.

Preferred developments of the present invention are disclosed herein.

According to an example embodiment of the present invention, preferably, the at least two sensor elements are configured to transmit at least a second ultrasonic wave, wherein the sensor unit is configured to adjust a phase offset between the first ultrasonic wave and the second ultrasonic wave in order to ascertain the orientation of the sensor unit.

An advantage of this example embodiment is that the second ultrasonic wave can be used to further improve the accuracy of detecting the orientation of the sensor unit in relation to the reference of the vehicle. Preferably, the two sensor elements may transmit a plurality of ultrasonic waves, which may be used, by adjusting the phase offset from one another, to ascertain the orientation of the sensor unit.

According to an example embodiment of the present invention, further preferably, the sensor unit is configured to adjust the phase offset such that a first maximum of the first ultrasonic wave and/or a second maximum of the second ultrasonic wave move along a first axis and/or a second axis.

An advantage of this example embodiment is that different reflection surfaces can be selected by means of the sensor unit in order to be able to ascertain the orientation of the sensor unit. For example, by adjusting the phase offset, the maximum of the wave front may be changed upward or downward as well as to the left and to the right, starting from the sensor unit. For example, the first axis may in particular be aligned orthogonally to a placement area of a vehicle, and/or the second axis may be aligned substantially orthogonally to the first axis.

Preferably, according to an example embodiment of the present invention, the sensor unit is configured to transmit the first ultrasonic wave on the basis of a predetermined alignment, wherein the sensor unit is configured to compare the propagation time of the first ultrasonic wave in the predetermined alignment to a predetermined reference value in order to determine the orientation of the sensor unit.

On the basis of the expected distribution of the time offset in the predefined alignment or angle of incidence, it can be validated whether the ultrasonic system has been installed correctly.

According to an example embodiment of the present invention, further preferably, the sensor unit is configured to receive an initiation signal, wherein the sensor unit is configured to ascertain the orientation of the sensor unit if the initiation signal is present.

An advantage of this example embodiment is that a central unit, such as a control unit of a vehicle, may initiate the ascertainment of the orientation of the sensor unit. In particular, the control unit of the vehicle may check whether all sensor units are available to the control unit, in order subsequently to be able to ascertain all orientations of the sensor units and to be able to compare them to one another.

Preferably, according to an example embodiment of the present invention, the sensor unit is configured to receive a temperature value and/or a geographic position, wherein the sensor unit is configured to adjust the orientation of the sensor unit on the basis of the temperature value and/or the geographic position.

An advantage of this example embodiment is that the speed of sound changes on the basis of, for example, the altitude or the air pressure and that, on the basis of the ambient temperature and the GPS coordinates or geographic position, the ascertainment of the orientation is improved or can be adjusted on the basis of the corresponding speed of sound.

Another aspect of the present invention relates to a vehicle comprising a first sensor unit as described above and below, wherein the first sensor unit is configured to transmit at least a first ultrasonic wave, wherein the first sensor unit is configured to determine a first orientation of the first sensor unit in relation to a reference of the vehicle by adjusting the first transmitted ultrasonic wave.

For example, the vehicle may comprise a parking sensor, such as an ultrasonic parking sensor, or the like. Preferably, the ultrasonic parking sensors are arranged in the front area and rear area of the vehicle. Thus, the first sensor unit of the vehicle may in particular be aligned such that it can monitor a ground area in the front area or rear area of the vehicle. By means of a first transmitted ultrasonic wave, the sensor unit can determine and/or ascertain an orientation of the first sensor unit in relation to the reference of the vehicle so that a correct installation position of the sensor unit can be checked.

Further preferably, according to an example embodiment of the present invention, the vehicle comprises a second sensor unit, as described above and below, wherein the second sensor unit is configured to transmit a third ultrasonic wave, wherein the second sensor unit is configured to ascertain a second orientation between the second sensor unit and the reference of the vehicle by adjusting the third ultrasonic wave, wherein the vehicle is configured to adjust the first orientation and/or the second orientation on the basis of a comparison between the first orientation and the second orientation.

An advantage of this example embodiment is that the comparison of the first orientation and the second orientation can be used to detect any incorrect ascertainment of the orientation, and the ascertainment of the orientation of the first sensor unit and/or of the second sensor unit may be repeated. Preferably, like the first sensor unit, the second sensor unit is arranged in the rear area or in the front area.

According to an example embodiment of the present invention, further preferably, the vehicle has an axis of symmetry, wherein the first sensor unit and the second sensor unit are arranged substantially symmetrically to the axis of symmetry.

An advantage of this example embodiment is that substantially similar and/or identical conditions exist for the first sensor unit and the second sensor unit if they are arranged symmetrically with respect to each other in order to be able to further increase the comparability of the recorded ultrasonic values. For example, the axis of symmetry may be a longitudinal axis of a vehicle so that the first sensor unit is arranged on a left side and the second sensor unit is arranged on the right side of the vehicle. Preferably, the comparability of the received ultrasonic values as well as the ascertained orientations can thus be compared with one another. In this context, “substantially symmetrically” in particular means a deviation of +/−5%, in particular manufacturing-related tolerances.

According to an example embodiment of the present invention, preferably, the first sensor unit is configured to transmit a first ultrasonic wave set, wherein the second sensor unit is configured to receive at least a portion of the first ultrasonic wave set in order to ascertain the second orientation.

An advantage of this example embodiment is that a sensor unit on the vehicle can transmit an ultrasonic wave set and a plurality of further or adjacent sensors can receive the reflection. In this way, assuming a vehicle on level ground, the position of the sensor units in relation to one another can be checked. Statistical methods may in particular be used here.

### BRIEF DESCRIPTION OF THE DRAWINGS

Exemplary embodiments of the present invention are described in detail below with reference to the figures.

FIG. 1 shows a sensor unit according to one example embodiment of the present invention.

FIG. 2 shows a vehicle according to one example embodiment of the present invention.

FIG. 3 shows a vehicle according to one example embodiment of the present invention.

### DETAILED DESCRIPTION OF EXAMPLE EMBODIMENTS

All identical elements, units and/or systems are preferably provided with the same reference signs in all figures.

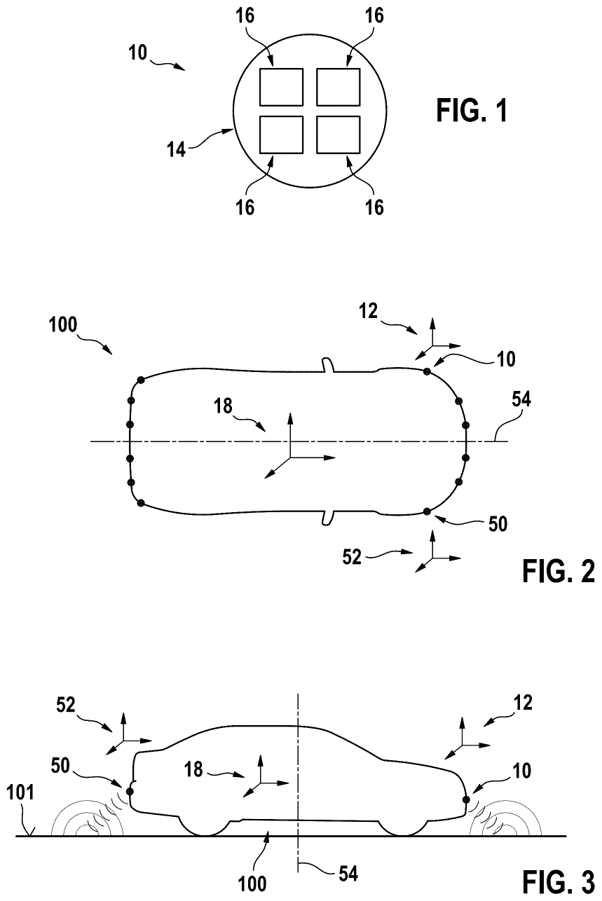

FIG. 1 shows a sensor unit 10 according to one embodiment. Preferably, the sensor unit 10 for ascertaining an orientation 12 of the sensor unit 10 comprises a printed circuit board unit 14 and at least two sensor elements 16, wherein the two sensor elements 16 are arranged on the printed circuit board unit 14, wherein the at least two sensor elements 16 are configured to transmit and/or receive at least a first ultrasonic wave, wherein the sensor unit 10 is configured to ascertain the orientation 12 of the sensor unit 10 in relation to a reference 18 of a vehicle by adjusting the first transmitted ultrasonic wave by means of the at least two sensor elements 16.

As shown in FIG. 1, the sensor unit 10, which may in particular be a MEMS-based ultrasonic sensor array, comprises at least one printed circuit board unit 14. At least two sensor elements 16, such as ultrasonic sensors, may be arranged on the printed circuit board unit 14. As shown in FIG. 1, four sensor elements 16 are arranged in a 2×2 array on the printed circuit board unit. Thus, the sensor unit 10 can transmit and/or receive at least a first ultrasonic wave by means of the two sensor elements or four sensor elements, preferably transmit and/or receive a second ultrasonic wave, and/or further preferably transmit and/or receive a plurality of ultrasonic waves. Further preferably, the sensor unit 10 may be configured to adjust a phase offset between the first ultrasonic wave and the second ultrasonic wave in order to ascertain the orientation 12 of the sensor unit 10. Here, the wave front may preferably be aligned upward/downward as well as to the left/right by adjusting the phase offset by means of the excitation by the sensor elements 16.

FIG. 2 shows a vehicle 100 according to one embodiment. Preferably, the vehicle 100 comprises at least a first sensor unit 10. Preferably, the first sensor unit 10 is configured to transmit at least a first ultrasonic wave, wherein the first sensor unit 10 is configured to determine a first orientation 12 of the first sensor unit 10 in relation to a reference 18 of the vehicle 100 by adjusting the first transmitted ultrasonic wave. As shown in FIG. 2, the first sensor unit 10 is located in a front area of the vehicle 100, in particular on a first side in relation to the axis of symmetry 54. As shown in FIG. 2, the axis of symmetry 54 may preferably be a longitudinal axis of symmetry of the vehicle 100. Further preferably, the vehicle 100 has a reference 18, which may in particular be a coordinate system or the like in accordance with DIN 70000. Further preferably, the vehicle 100 comprises a second sensor unit 50. The second sensor unit 50 may be configured to ascertain a second orientation 52. As shown in FIG. 2, the second sensor unit 50 is located on a second side in relation to the axis of symmetry 54. For example, the first sensor unit 10 may transmit a first ultrasonic wave set, for example in a front area of the vehicle 100. Thus, a second sensor unit 50, or a plurality of further ultrasonic sensors, may receive at least a portion of the ultrasonic wave set in order thus to be able to ascertain the second orientation 52.

FIG. 3 shows a vehicle 100 according to one embodiment. The vehicle 100 comprises a sensor unit 10 for determining a first orientation 12 and a second sensor unit 50 for determining a second orientation 52 in relation to a reference 18 of the vehicle 100. As shown in FIG. 3, the vehicle 100 is located on a placement area 101. The first sensor unit 10 and the second sensor unit 50 can transmit at least one ultrasonic wave onto the placement area 101 and ascertain an orientation 12 and 52, respectively, in relation to the reference 18 of the vehicle 100 on the basis of the reflection or the changes in the ultrasonic wave by means of beamforming.

What is claimed is:

1. A sensor unit configured to ascertain an orientation of the sensor unit, comprising:
a printed circuit board unit; and
at least two sensor elements arranged on the printed circuit board unit, the at least two sensor elements being configured to transmit and/or receive at least a first ultrasonic wave;
wherein the sensor unit is configured to ascertain the orientation of the sensor unit in relation to a reference of a vehicle by adjusting the first transmitted ultrasonic wave using the at least two sensor elements.

2. The sensor unit according to claim 1, wherein the at least two sensor elements are configured to transmit at least a second ultrasonic wave, wherein the sensor unit is configured to adjust a phase offset between the first ultrasonic wave and the second ultrasonic wave to ascertain the orientation of the sensor unit.

3. The sensor unit according to claim 2, wherein the sensor unit is configured to adjust the phase offset such that a first maximum of the first ultrasonic wave and/or a second maximum of the second ultrasonic wave move along a first axis and/or a second axis.

4. The sensor unit according to claim 1, wherein the sensor unit is configured to transmit the first ultrasonic wave based on a predetermined alignment, wherein the sensor unit is configured to compare a propagation time of the ultrasonic wave in the predetermined alignment to a predetermined reference value in order to determine the orientation of the sensor unit.

5. The sensor unit according to claim 1, wherein the sensor unit is configured to receive an initiation signal, wherein the sensor unit is configured to ascertain the orientation of the sensor unit when the initiation signal is present.

6. The sensor unit according to claim 1, wherein the sensor unit is configured to receive a temperature value and/or a geographic position, wherein the sensor unit is configured to adjust the orientation of the sensor unit based on the temperature value and/or the geographic position.

7. A vehicle, comprising:
a first sensor unit including:
a printed circuit board unit, and
at least two sensor elements arranged on the printed circuit board unit;
wherein the first sensor unit is configured to transmit at least a first ultrasonic wave, wherein the sensor unit is configured to determine a first orientation of the first sensor unit in relation to a reference of the vehicle by adjusting the first transmitted ultrasonic wave.

8. The vehicle according to claim 7, further comprising:
a second sensor unit including:
a printed circuit board unit, and
at least two sensor elements arranged on the printed circuit board unit;
the second sensor unit is configured to transmit a third ultrasonic wave, wherein the sensor unit is configured to ascertain a second orientation between the second sensor unit and the reference of the vehicle by adjusting the third ultrasonic wave, wherein the vehicle is configured to adjust the first orientation and/or the second orientation based on a comparison between the first orientation and the second orientation.

9. The vehicle according to claim 8, wherein the vehicle has an axis of symmetry, wherein the first sensor unit and the second sensor unit are arranged substantially symmetrically to the axis of symmetry.

10. The vehicle according to claim 8, wherein the first sensor unit is configured to transmit a first ultrasonic wave set, wherein the second sensor unit is configured to receive at least a portion of the first ultrasonic wave set in order to ascertain the second orientation.
